(19) United States
(12) Patent Application Publication
(10) Pub. No.: US 2020/0262734 A1
(43) Pub. Date: Aug. 20, 2020

(54) METHOD AND APPARATUS FOR PROCESSING GLASS TUBE ENDS

(71) Applicant: SCHOTT AG, Mainz (DE)

(72) Inventors: Franz Volkl, Friedenfels (DE); Volker Trinks, Mitterteich (DE)

(73) Assignee: SCHOTT AG, Mainz (DE)

(21) Appl. No.: 16/790,836

(22) Filed: Feb. 14, 2020

(30) Foreign Application Priority Data
Feb. 18, 2019 (EP) 19157844.2

(51) Int. Cl. C03B 27/06

(52) U.S. Cl. CPC C03B 27/062; C03B 33/095

(57) ABSTRACT

A method for processing glass tube ends is provided. The method includes providing a glass tube blank that has at least two tube end portions; actively cooling at least one tube end portion by a cooling station; and processing the at least one of the tube end portion.

### CROSS REFERENCE TO RELATED APPLICATIONS

This application claims benefit under 35 USC § 119 of European Application 19157844.2 filed Feb. 18, 2019, the entire contents of which are incorporated herein by reference.

### BACKGROUND

### 1. Field of the Invention

The invention relates to a method and an apparatus for processing glass tube ends.

### 2. Description of Related Art

In the production of glass tubes, glass tube blanks are separated from a continuously running endless strand of glass and transferred individually and in a precisely divided manner to subsequent processing processes, where they are then further processed. The individual systems for processing the glass tube blanks are arranged in succession and thus form a processing line.

During the further processing, the ends of the separated tubes are processed, with it being possible to produce different types of ends. The ends can be open or closed ends, for example. The thus produced tubes are used, for example, as special glass tubes for pharmaceutical packagings. What is concerned here are intermediate products for further processing to form vials, ampoules, syringes, carpoules and the like. The highest possible quality requirements in terms of cleanness and dimensional accuracy are placed precisely on such special glass tubes.

In known methods, glass tube blanks which have been separated from the endless strand cool slowly during the continuous conveyance by means of a conveying apparatus. At the same time, subregions of the glass tube blanks, in particular the tube end portions, are heated locally by thermal processing steps. US Publication 2011/005275 discloses such a method, for example.

DE 102 00 144 B4 discloses, for example, a method for separating a material, in particular glass, in which the material is scored and then irradiated with a laser. Here, the laser has a wavelength in the range in which the material absorbs the radiation. As a result, the material can absorb the energy of the laser and be heated. This ensures stresses which sever the material. Separating methods by means of a laser are also known from DE 42 14 159 C1 and U.S. Pat. No. 5,902,368.

The individual steps are carried out at certain positions of the processing line, with the positions being associated in each case with a temperature of a glass tube blank, in dependence on the conveying speed. The position of a station which is intended to carry out a processing step is chosen such that the temperature of the glass tube blanks is cooled to a level at which the further processing can be carried out. For example, scoring and rupturing processes can be carried out only at low tube temperatures. The system which carries out such a rupturing process must thus be correspondingly positioned far downstream on the processing line. On account of the late scoring and rupturing processes and the associated preheating process at the separating points, there is additionally the risk of condensation water formation within the glass tube blank. Here, the water vapour from the burner exhaust gases condenses on the tube inner surface, resulting in deposits on the tube inner surface. This adversely affects the quality of the glass tubes to be produced and leads to failure of the product.

A further problem consists in the fact that the temperature of the glass tube blank at the individual stations for processing depends substantially on the room temperature and in particular on the conveying speed of the conveying device for the glass tube blanks. The conveying speed for its part is determined by the quantity of glass constantly delivered from the glass-supply trough and the geometric properties of the product to be produced.

If, for example, glass tubes are produced with a small volume and/or small wall thickness, less glass is necessary per glass tube and the conveying speed is high in order to transport away the high number of glass tube blanks. If, by contrast, glass tubes are produced with a high volume and/or high wall thickness, a lot of glass is required for each glass tube and the conveying speed is low. The geometry of the glass tubes to be produced thus directly influences the conveying speed of the glass tube blanks and their temperature at the individual systems for processing. Different geometries thus result in different temperatures for the respective processing steps. This adversely affects the quality since not all glass tube blanks can be processed with the optimum temperature.

### SUMMARY

The object on which the present invention is based is thus to provide an improved method and an improved apparatus for processing glass tube ends.

In a first aspect, the invention relates to a method for processing glass tube ends, wherein the method comprises the following steps: providing a glass tube blank, wherein the glass tube blank comprises at least two tube end portions, and processing at least one of the tube end portions.

After providing the glass tube blank and before processing the at least one tube end portion, the at least one tube end portion is actively cooled by means of a cooling station.

The provision of a glass tube blank comprises at least the ordered feeding of the separated glass tube blank to the processing stations arranged downstream of the separating location and is thus a part of the production process in which the provision is preceded by a withdrawal of a glass tube strand (also referred to as endless strand) from a glass-tube production installation and the severing of the glass tube blank from the glass tube strand. During the provision, the glass tube blanks can have a temperature in a temperature range with a lower limit of 150° C., in particular of 200° C. and preferably 250° C., and an upper limit of 400° C., in particular of 350° C. and preferably 300° C.

The processing of a tube end portion comprises, for example, a scoring and rupturing operation, in order to produce a defined edge of the tube end portion, a drilling operation on the tube end portion, in order to create a pressure-equalizing hole for the subsequent end product, and/or a closing operation on the tube end portion, in order to produce a glass tube with one or two closed ends.

Active cooling is to be understood as meaning a cooling operation in which a coolant is used and, by contrast to passive cooling, energy is expended.

Passive cooling can also occur using a coolant. For example, for cooling, heat exchangers can be filled with a coolant which transports heat away from the tube end portions by convection. Such a system would not require its own energy supply, whereby no energy would have to be expended.

The coolant can in particular comprise, without being restricted thereto, air, mist or a specific gas mixture. Mist is understood to mean a gas, in particular air, in which there are distributed water droplets which do not exceed a droplet size of 20 μm. When using liquid coolants, in particular cryogenic liquids such as liquid nitrogen, liquid CO₂ or other liquid gases, the cooling station is positioned such that the liquid completely evaporates before contact with the tube end portions. Furthermore, the coolant can be precooled, in particular with the expenditure of energy. The energy can further be expended to move the coolant, in particular to circulate it in a coolant circuit or to guide it as a directed flow onto the tube end portions.

The active cooling further reduces the path which a glass tube blank must cover in the processing line in order to reach the optimum temperature (referred to hereinbelow as cooling path). As a result, the required space for an apparatus for carrying out a method for processing glass tube ends is reduced. The reduction of the cooling path and the active cooling further advantageously have the effect of avoiding the formation of condensation water on the tube inner surfaces, with the result that the quality of the processing is further improved.

In one embodiment, the at least one tube end portion is cooled to a predefined temperature by the active cooling. The predefined temperature is preferably a temperature between 100° C. and 120° C.

The active cooling to a predefined temperature of the at least one tube end portion ensures that the optimum temperature for the respective subsequent processing of the tube end or of the tube ends is achieved. Because the active cooling acts only on the tube end(s), the cooling remains substantially without influence on the temperature conditions in the remainder of the glass tube. In particular, condensation formation and harmful stresses between the glass tube ends can thus be avoided and overall a higher and uniform quality of the glass tubes can be ensured for different glass tube geometries on the same production installation.

The predefined temperature is conditioned by the subsequent processing steps. The required cooling power can be adapted to various influencing factors. These influencing factors also include, in addition to the conveying speed, the inlet-side tube temperature, that is to say the temperature of the glass tube blank upstream of the cooling path, the tube geometry and environmental parameters, such as, for example, the ambient temperature and the air moisture.

In particular, a setting of the cooling power of the cooling station can therefore precede the active cooling to a predefined temperature in order to achieve the predefined temperature. The cooling power to be set for a certain temperature is first of all dependent on the quantity of heat to be removed and thus, inter alia, on the predefined temperature itself, on the geometry of the glass tube blanks, but also on the conveying speed, in particular the time which a glass tube blank spends on the cooling path. As a result of the setting of the cooling power and of the subsequent cooling to the predefined temperature, the cooling can be adapted to different glass tube geometries. Consequently, the cooling down to a predefined temperature is to be delimited from a simple cooling without a specified target.

In a further embodiment, the at least one cooling station uses a directed coolant flow for the active cooling. The coolant flow is for example, without being limited thereto, in the form of a gas flow, in particular an air flow, a flow of nitrogen or a flow of a mist. The coolant flow can, for example, be directed by means of a nozzle onto the at least one tube end portion such that the tube end portion is cooled to suit the requirements for the further processing and, for example, the predefined temperature is achieved.

In an advantageous manner, the production of a coolant flow, in particular of an air flow, is a cost-effective possibility of providing effective cooling for a method for the processing of glass tube ends. Furthermore, cooling by a coolant flow can be easily controlled in that, for example, the mass flow of the coolant used is regulated or the coolant itself is precooled to different degrees.

In a further embodiment, the method comprises, after providing the glass tube blank, the following steps: (a) detecting the temperature of the at least one tube end portion by means of at least one sensor, and (b) controlling the cooling station on the basis of the detected temperature of the at least one tube end portion.

The steps (a) and (b) can be continuously carried out one or more times or in a control loop before, after or during the active cooling of the at least one tube end portion. For this purpose, the sensor(s) can be arranged upstream, downstream and/or in the cooling station.

In an advantageous manner it is possible, as a result of the detection of the temperature and the detection-coupled control of the cooling station, for the temperature of the at least one tube end portion to be controlled more precisely or to be adapted to the geometry of the glass tube to be produced. Should, for example, the cooling station use a non-precooled air flow for the active cooling and should the room temperature change, for example because an air-conditioning system does not function correctly or the weather changes, the cooling power of the cooling station would also change. A, for example, reduced cooling effect can be detected by the sensor, whereupon the cooling station is activated to increase the cooling power.

In a further aspect, the invention relates to an apparatus for processing glass tube ends, wherein the apparatus comprises a conveying device for glass tube blanks having at least two tube end portions, and at least one processing system for processing at least one tube end portion, wherein the conveying device is designed to transport glass tube blanks transversely in a conveying direction, wherein the at least one processing system is positioned next to the conveying device perpendicularly to the conveying direction, characterized in that at least one active cooling station is positioned next to the conveying device in the conveying direction upstream of the at least one processing system and perpendicularly to the conveying direction.

The at least one processing system can comprise one of the aforementioned systems for processing glass tube ends, in particular a gas burner, a laser or another suitable system for scoring the tube end portion, a station for rupturing a part of the at least one tube end portion, a holing station and/or a station for closing the glass tube.

The conveying device can be designed in particular as a conveyor belt. The conveying device extends in a conveying direction in which the glass tube blanks are transported after being severed from the endless strand. The glass tube blanks have a main extent axis. The glass tube blanks are transported transversely, that is to say perpendicularly to their main extent axis, by the conveying device. Furthermore, the glass tube blanks are preferably transported and processed in a horizontal position.

The apparatus comprises at least one, and preferably two, active cooling stations which, in the conveying direction, are positioned at in each case one end of the glass tube blank next to the conveying apparatus.

The at least one active cooling station is an apparatus which is suitable for acting by means of a coolant on the tube end portions of the glass tube blanks. By contrast to a passive cooling station, such as, for example, a heat exchanger, an active cooling station expends energy in order to achieve a cooling action.

The at least one active cooling station is positioned next to the conveying device in order to cool the tube end portions of the glass tube blanks which are transported by the conveying device. The cooling station is positioned next to the conveying device in particular in the region of the tube end portions, that is to say the region through which the tube end portions move during conveyance. The cooling station is preferably positioned at a distance of a few millimetres to a few centimetres from the region of the tube end portions, thereby ensuring that the cooling action of the cooling station reaches the tube end portions with minimum losses.

In a further embodiment, the at least one active cooling station comprises an apparatus for generating a directed coolant flow.

An apparatus for generating a directed coolant flow comprises at least one coolant feed and a nozzle connected thereto. The coolant feed can be connected, for example, to a compressor which for its part is a constituent part of the cooling station. The at least one compressor sucks in coolant and thus generates a pressure difference between its suction side and its outlet side which is connected to the nozzle. As an alternative to a compressor, use can also be made of a pump or a similar device for moving fluids. Alternatively, precompressed coolant can also be provided from a network or from a reservoir to which the coolant feed can be connected.

The at least one nozzle is fluidically coupled to the compressor, with the result that the generated pressure difference brings about a coolant flow out of the nozzle. By virtue of its shape, the nozzle determines the direction and the shape of the coolant flow.

The coolant flow can preferably be oriented by means of the blower. The blower can in particular be oriented onto the tube end portions of the conveyed glass tube blanks. This means that the nozzle is designed in such a way that the coolant flow strikes the tube end portions.

In a further preferred embodiment, the blower comprises a slotted nozzle, wherein the slotted nozzle extends parallel to the conveying direction. The slotted nozzle can have in particular a length of more than 0.05 metres, in particular of more than 0.5 metres, and less than two metres.

A slotted nozzle is to be understood as meaning a nozzle which has a slot-shaped opening out of which the coolant flows. The shape which the coolant flow assumes here corresponds to a flat flow extended in the conveying direction.

In an advantageous manner, a slotted nozzle is suitable for generating along its direction of extent a continuous coolant flow through which the glass tube blanks travel with a constant speed during operation of the apparatus. The tube end portions are uniformly cooled by the continuous coolant flow, with the result that the risk of unwanted thermal stresses is reduced. Particularly in the case of a short and powerful coolant impact, a high cooling gradient can be produced by contrast to a continuous and comparatively slow cooling. A high cooling gradient in turn results in undesired local stresses in the glass which are avoided by the continuous cooling.

In a further embodiment, the blower comprises at least two nozzles, wherein the at least two nozzles are arranged on mutually opposite sides of a horizontal plane extending in the conveying direction.

If the glass tube blanks are transported along the conveying direction, they move parallel to this plane. The tube end portions pass in this way through a region above and below which the at least two nozzles are arranged or which the at least two nozzles at least partially engage around. The tube end portions are thus advantageously uniformly cooled from above and from below. The at least can in particular each be designed as slotted nozzles which extend parallel to the conveying direction.

Furthermore, the blower can also have three or more nozzles of which at least two nozzles are arranged, as described above, on mutually opposite sides and at least one nozzle can be oriented end-on onto the tube end portions.

Furthermore, the blower can have, in side profile, that is to say viewed in or counter to the conveying direction, a u-shaped housing, wherein the opening of the u-shape points in the direction of the glass tube blanks. Furthermore, the u-shaped housing can extend parallel to the conveying direction, with the result that the housing is shaped like a channel, the tube end portions moving through the channel. The inner side of the u-shaped housing can have, for example, a plurality of holes which are arranged in one or more rows and parallel to the conveying direction. Alternatively or additionally, the u-shaped housing can have, on the inner side, one or more slot-shaped openings which extend parallel to the conveying direction. The coolant flows through the holes and/or openings. The holes and/or slot-shaped openings then thus form the nozzles.

By virtue of the distribution of the nozzles and/or the holes and/or openings forming the nozzles in the blower, the coolant flow can be oriented onto the tube end portions, thus allowing a targeted and precise cooling of individual subregions of the tube end portions.

In a further embodiment, the blower of the at least one cooling station is arranged in such a way that only the upper sides of the tube end portions or only the lower sides of the tube end portions are cooled.

In an alternative embodiment, the blower comprises at least one nozzle which can be moved in the conveying direction, wherein the cooling station comprises a drive which is coupled to the at least one nozzle and is configured to move the at least one nozzle in the conveying direction and synchronously with the conveying device.

The movement of the nozzle that is synchronous with the conveying device advantageously has the effect that the nozzle is in particular moved at the same conveying speed as the glass tube blanks are moved by the conveying device. Such a “concomitantly running” nozzle can be assigned to precisely one glass tube blank during cooling. The assignment of a nozzle to a glass tube blank in conjunction with the synchronous movement in relation to this glass tube blank allows a targeted and precise cooling of a subregion of the at least one tube end portion of the glass tube blank. In particular, in this embodiment, the nozzle can also be placed within the glass tube blank and advantageously cool the tube end portion or a subregion thereof from inside.

In a further embodiment, the apparatus comprises a sensor and a control unit, wherein the sensor, the control unit and the at least one cooling station are communicatively connected to one another, wherein the sensor is designed to detect a temperature and wherein the control unit is designed to control the at least one cooling station in dependence on the temperature detected by the sensor.

In particular, the sensor is designed to detect the temperature of a tube end portion. The sensor can particularly be designed as a thermometer, as an infrared sensor or as an NTC or PTC thermistor, measuring in a contacting or preferably contactless manner. A contactlessly measuring sensor furthermore offers the advantage that the glass tube blank cannot be contaminated by a contact with the sensor.

The communicative connection between the sensor, the control unit and the cooling station can be designed as a wired or wireless connection, in particular as a radio, NFC, RFID, WLAN, optical, analogue or optoelectronic connection.

The control unit can be designed in particular as a PID controller, as a computer or as another apparatus suitable for data processing.

In an advantageous manner, the sensor and the control unit have the effect that the cooling station can react to changing boundary conditions of the processing line, in particular a changing ambient temperature, with the result that the apparatus for processing glass tube blanks becomes more flexible with respect to thermal boundary conditions.

The sensor can be positioned for example upstream of the at least one cooling station and carry out a predetermination of the temperature of the still to be cooled tube end portion. In an advantageous manner, the cooling power of the at least one cooling station can be adapted to correspond to the temperature of the still to be cooled tube end portion. This makes it possible in particular to compensate for a change in the room temperature.

Furthermore, the sensor can be positioned for example downstream of the at least one cooling station and carry out a post-determination of the temperature of the already cooled tube end portion. This allows a regulation which particularly takes into account a change in the cooling power of the cooling station or in the ambient conditions.

In a further embodiment, the apparatus comprises a plurality of sensors. The sensors can be positioned in particular upstream and downstream of the at least one cooling station and detect the temperatures of a plurality of tube end portions during the cooling of the tube end portions. It is thus possible to detect an actual temperature profile of the tube end portions which indicates the temperature of the tube end portions to be cooled in dependence on the position on the processing line. The actual temperature profile can be compared with a desired temperature profile which indicates a predefined temperature for each position of the tube end portions on the processing line.

In an advantageous manner, the control unit can cause the at least one cooling station to react to any deviation of the actual temperature profile from the desired temperature profile and activate the at least one cooling station corresponding to the deviation.

In a further embodiment, the at least one active cooling station comprises a cooling unit and the blower comprises a coolant line, wherein the cooling unit is arranged on the coolant line. In this embodiment, the coolant line extends from the compressor to the at least one nozzle of the blower.

In an advantageous manner, the cooling unit can cool the coolant within the coolant line and thus increase the cooling power of the cooling station.

### BRIEF DESCRIPTION OF THE FIGURES

FIG. 1 shows a schematic view of an apparatus for processing glass tube ends, as is known from the prior art,

FIG. 2 shows a schematic view of an apparatus for processing glass tube ends having at least one cooling station,

FIG. 3 shows a first blower having a nozzle in side profile,

FIG. 4 shows a second blower having a nozzle in side profile,

FIG. 5 shows a third blower having two nozzles in side profile,

FIG. 6 shows a fourth blower having a U-shaped nozzle arrangement in side profile,

FIG. 7 shows a fifth blower having a concomitantly running nozzle in side profile,

FIG. 8 shows a section of an embodiment of the cooling station,

FIG. 9 shows the flow diagram of a method for processing glass tube ends, and

FIG. 10 shows the flow diagram of a further embodiment of a method for processing glass tube ends.

### DETAILED DESCRIPTION

In the following, the directional indications “left” and “right” refer to “left in the conveying direction” and “right in the conveying direction”.

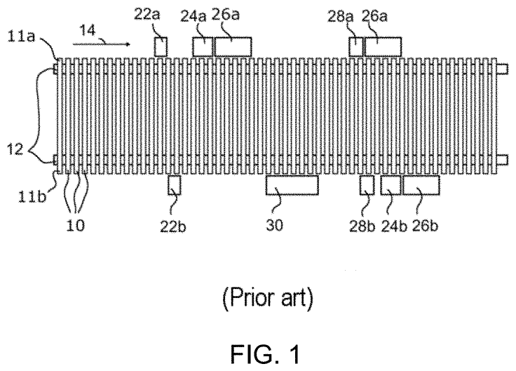

FIG. 1 shows a schematic view from above of an apparatus for processing glass tube ends, as is known from the prior art. The processing begins with the provision of glass tube blanks 10 having at least two tube end portions 11a and 11b. During provision, the glass tube blanks 10 have a temperature in a temperature range having a lower limit of 150° C., in particular of 200° C. and preferably 250° C., and an upper limit of 400° C., in particular of 350° C. and preferably 300° C. The glass tube blanks 10 are transported transversely in a conveying direction 14 by a conveying device 12. Here, “transversely” means that the glass tube blanks 10 extend perpendicularly or substantially perpendicularly to a conveying direction 14. The conveying direction 14 is determined by the conveying device 12. During conveyance by the conveying device 12, the tube end portions 11a and 11b of the glass tube blanks 10 project on the left and right beyond the conveying device 12, with the result that the tube end portions 11a and 11b can be processed by the following processing stations.

The apparatus illustrated is capable of processing different types of glass tubes in a processing line. These include closed glass tubes whose tube end portions are both closed, half-closed glass tubes in which only one tube end portion is closed, and open glass tubes in which both tube end portions are unclosed. Depending on which glass tube type is produced, use is made of different stations.

In a first exemplary processing step, contaminating or excess particles are removed from the left tube end portions 11a and right tube end portions 11b. This is achieved by the left station 22a for particle removal and right station 22b for particle removal.

A station 24a for closing the left tube end portions 11a is positioned downstream of the stations 22a and 22b for particle removal at a distance which is relatively short in relation to the overall length of the processing line. In general, the material for closing the tube end portions must be soft and shapeable. Therefore, it is appropriate for the station 24a for closing to be arranged rather at the start of the processing line, that is to say not far downstream of the station 22a for particle removal.

The situation for the station 24b for closing the right tube end portions 11b is different. Specifically, if the tube end portions 11b on the right are also closed, the right tube end portions 11b must first be provided with a hole for pressure equalization. The holing of the right tube end portions 11b is performed by a holing station 30. Since the exact position of the hole on the glass tube blanks 10 depends on a desired length or useful length of the finished glass tubes, the holing station 30 can be positioned in the conveying direction 14 only downstream of the burner station 26a, which follows the station 24a for closing on the left side. Thus, the position of the hole in the glass tube blank is ensured at a defined distance from the already finished left tube side. Furthermore, the temperature of the glass tube blanks 10, in particular of the right tube end portions 11b for the processing by the holing station 30, must be sufficiently cooled, with the result that the holing station 30 is positioned further downstream in the processing line.

Downstream of the holing station 30 there is then provided, on the right side, a further station 24b for closing, which closes the right tube end portions 11b.

For the thermal post-processing of the closed tube end portions 11a for the purpose of relaxation of the glass or avoidance of stress therein, a burner station 26a and 26b is positioned in the conveying direction 14 in each case directly downstream of the stations 24a and 24b for closing.

The tube end portions 11a and/or 11b are post-processed also in the case of glass tubes having one or two open tube ends. This post-processing can comprise, for example, a scoring and rupturing of the tube ends in order to obtain a defined length and a clean termination. For this purpose, the stations 28a and 28b for scoring and rupturing are provided on the left and on the right side. The stations 28a and 28b for scoring and rupturing are positioned far downstream in the processing line to ensure that the glass tube blanks 10 are cooled up to that point to an optimum temperature for this processing of less than 120° C. Burner stations 26a and 26b are also in each case again positioned adjoining the stations 28a and 28b for scoring and rupturing, wherein the burner station 26b actually adjoins the station 24b for closing because the distance between the latter and the station 28b for scoring and rupturing is comparatively small, with the result that a burner station can be used for the thermal post-processing of both processing steps. The burner stations 26a and 26b heat the ruptured tube end portions 11a and 11b again in order to smooth the edge which has resulted from the rupturing and to avoid unwanted stresses in the glass.

As has already been noted, not all processing stations are used for a product. The apparatus according to FIG. 1 is therefore designed for the production of different products. If an installation is designed for a product which always remains the same, the apparatus can comprise, for example, just one side of the processing line, that is to say for example only the left or only the right side. Furthermore, the apparatus can comprise just the stations 24a and/or 24b for closing or the stations 28a and/or 28b for scoring and rupturing.

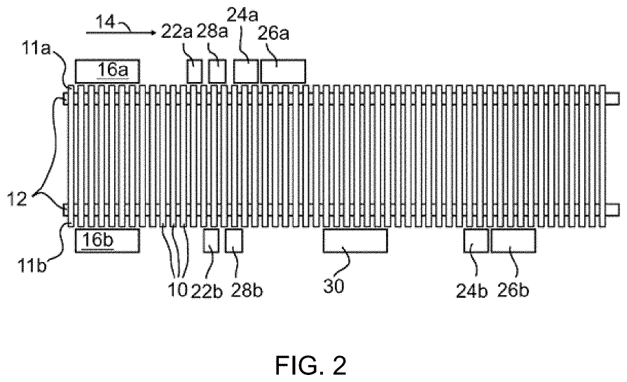

FIG. 2 shows a schematic view from above of an embodiment of an apparatus according to the invention for processing glass tube ends which, in addition to the processing stations from FIG. 1, further comprises two cooling stations 16a and 16b. In the embodiment illustrated, the apparatus comprises a cooling station 16a on the left side and a cooling station 16b on the right side of the apparatus.

The cooling stations 16a and 16b are positioned at the start of the processing line. Consequently, the cooling stations 16a and 16b can cool the tube end portions 11a and 11b directly after the provision of the glass tube blanks 10. The cooling of the tube end portions 11a and 11b by the cooling stations 16a and 16b therefore has the effect not only that the temperature for the processing of the tube end portions 11a and 11b is regulated to a uniform level. In particular, the active cooling accelerates the cooling process by contrast to a passive cooling of the tube end portions 11a and 11b in air, as is the case in an apparatus without cooling station according to FIG. 1. The path is thus shortened between the start of the processing line and the first processing stations, which are here the stations 22a and 22b for particle removal. In particular, the stations 28a and 28b for scoring and rupturing can be moved upstream, since the optimum temperature therefor of below 120° C. is more quickly achieved.

For apparatuses without stations 24a and/or 24b for closing, it is possible, by contrast to an apparatus without cooling stations 16a and 16b, by using the cooling stations 16a and/or 16b, to save on a path of about 2 m or about 10% of the length of the processing line.

Furthermore, in the case of apparatuses which comprise both a station 28a for scoring and rupturing and a station 24a for closing, the number of burner stations 26a can be reduced. Whereas the apparatus shown in FIG. 1 requires two burner stations 26a for the thermal post-processing of the closed tube end portions 11a on the one hand and the thermal post-processing of the glass tubes cut to length in the station 28a on the other hand, it is possible by moving the station 28a for scoring and rupturing upstream to reduce the distance between the latter and the station 24a for closing to such an extent that a burner station 26a can be used for the thermal post-processing for both processing steps 28a and 24a. The apparatus according to the invention is accordingly preferably further developed in that the processing system has a station 28a for scoring and rupturing and a station 24a for closing, wherein only precisely one burner station 26a for a thermal post-processing adjoins the station 28a for scoring and rupturing and the station 24a for closing.

In alternative embodiments, instead of two cooling stations 16a or 16b, the apparatus can comprise just one on the right or left side.

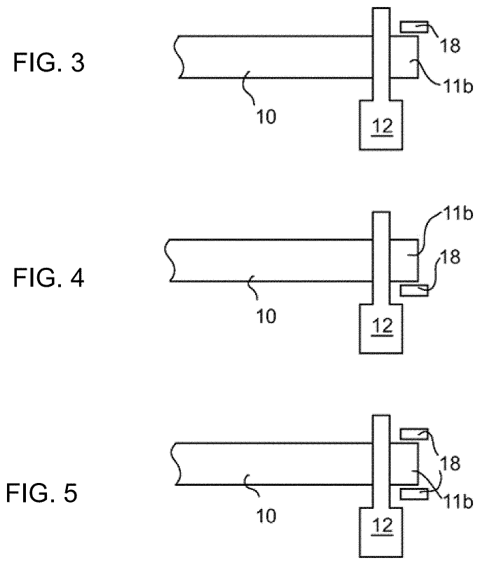

FIG. 3 shows a part of a glass tube blank 10 with the right tube end portion 11b in a view in the conveying direction 14. A nozzle 18 of the cooling station 16b (not illustrated further here), which is designed, for example, as a slotted nozzle, is illustrated here in abstracted form positioned above the tube end portion 11b. In this embodiment, the nozzle 18 cools the tube end portion 11b from above.

FIG. 4 shows an arrangement similar to that of FIG. 3. The arrangement of FIG. 4 differs from the arrangement in FIG. 3 in that the nozzle 18 is arranged (schematically) below the tube end portion 11b. In this embodiment, the nozzle 18 cools the tube end portion 11b from below.

FIG. 5 shows a combination of the arrangements from FIGS. 3 and 4. The nozzles 18 shown here are likewise part of a cooling station 16b (not illustrated further here) and engage around the tube end portion 11b from two sides, that is to say at least partially, with the result that the upper and the lower subregion of the tube end portion 11b are cooled simultaneously.

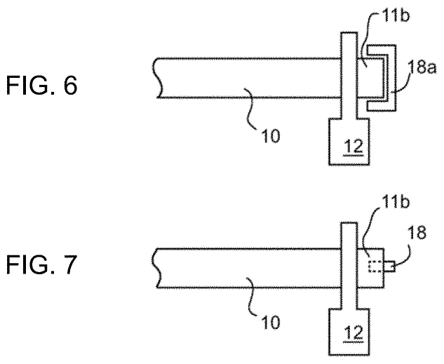

FIG. 6 shows a further embodiment of the arrangement of nozzles around the tube end portion 11b of the glass tube blank 10. In this embodiment, a housing 18a engages around the tube end portion 11b on three sides, with the result that the tube end portion 11b can be cooled from above, from below and from the side. For this purpose, the nozzles are formed in the u-shaped housing 18a on the inner side as a plurality of holes (bores, oblong holes, slots, etc.) through which a coolant flow, in particular an air flow, is directed from a plurality of directions onto the tube end portion 11b. In this embodiment, the tube end portion 11b can be uniformly cooled in a particularly advantageous manner.

FIG. 7 shows a further arrangement of the nozzle 18 in relation to the tube end portion 11b of the glass tube blank 10. In this embodiment, the nozzle 18 is at least partially inserted into the glass tube blank 10 and can cool the tube end portion 11b from inside. In this embodiment, at least the nozzle 18 has to be configured to be movable in the conveying direction, with the result that the nozzle 18 can move along synchronously with the glass tube blank 10.

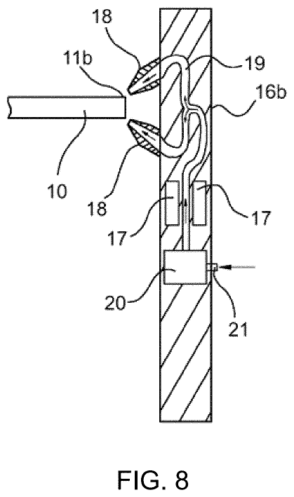

FIG. 8 shows a section in side view, that is to say with a viewing direction in or counter to the conveying direction, of an embodiment of the cooling station 16b. In the illustrated embodiment, the cooling station 16b comprises a compressor 20 which sucks in a coolant, preferably air, through a suction tube 21 and compresses it. The coolant is then forced by the compressor 20 through a coolant line 19, creating a coolant flow.

The cooling station 16b further comprises two nozzles 18 which are arranged above and below the tube end portion 11b. The nozzles 18 are fluidically connected to the compressor 20 via the coolant line 19. The nozzles 18 and the compressor 20 together form a unit, which is referred to as a blower. Furthermore, the nozzles 18 are arranged such that they direct the coolant flow onto the tube end portion 11b.

The cooling station 16b further comprises a cooling unit 17 through which the coolant line 19 is laid. The cooling unit 17 cools the coolant within the coolant line 19 while the coolant flows through the cooling unit 17. As a result, a coolant flow is produced from a precooled coolant.

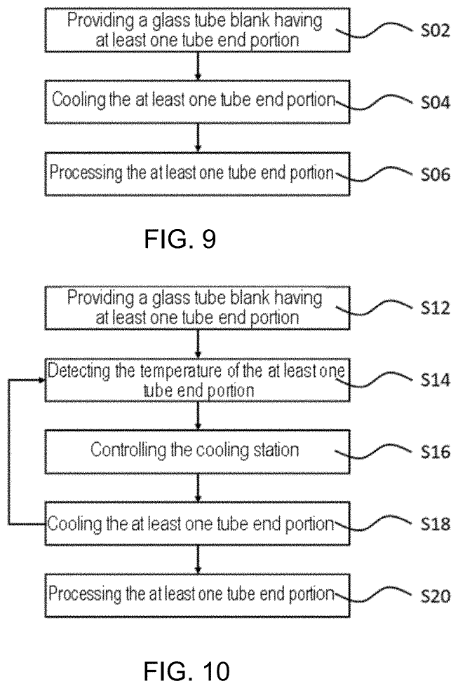

FIG. 9 is a flow diagram illustrating the method according to the invention according to a first embodiment for processing glass tube ends. The method begins with step S02, in which a glass tube blank having at least one tube end portion is provided. While the glass tube blank is transported by a conveying device in a conveying direction, the glass tube blank runs through various processes. After the glass tube blank has been provided, the latter passes through a cooling station, which cools the at least one tube end portion of the glass tube blank in step S04. The glass tube blank is then transported to various processing stations, where the at least one tube end portion is further processed in a final step S06.

FIG. 10 is a flow diagram illustrating an alternative variant of the method according to the invention from FIG. 9. This variant also begins with the provision of a glass tube blank having at least one tube end portion in step S12. Next, the temperature of the at least one tube end portion is first of all detected by means of a first sensor in step S14. Here, particularly the average value of the tube end temperatures can be detected and the cooling power can be adapted to the detected temperature in step S16. The changes in the cooling power can act, during the cooling in step S18, on a plurality of tube end portions which are currently situated in the region of the cooling station.

If there is fitted an additional sensor for monitoring the outlet temperature of the tube ends downstream of the cooling path, the method reverts to step S14. Effects of the tube geometry or of the heat transfers to the tube ends during cooling can thus be incorporated into the regulation of the cooling power, and the cooling power can be correspondingly adapted.

In a further embodiment, the cooling path can be subdivided into a plurality of successively following cascades which each comprise a sensor, a cooling path and a control system. The cooling and hence the temperature accuracy of the outlet-side temperature of the tube end portion can be still further optimized with an increasing number of cascades.

Alternatively, a concomitantly running temperature sensor and a concomitantly running cooling module per tube end portion can be used for the cooling. In this embodiment, the temperature of each individual tube end portion is measured continuously. The cooling can thus be regulated in such a way that the desired target temperature of the respective tube end portion is optimally achieved at the outlet of the cooling path.

In any case, there finally follows the step S20 in which the at least one tube end portion is processed.

### LIST OF REFERENCE SIGNS

10 glass tube blank
11a tube end portion
11b tube end portion
12 conveying device
14 conveying direction
16a cooling station
16b cooling station
17 cooling unit
18 nozzle
18a housing
19 coolant line
20 compressor
21 suction tube
22a station for particle removal
22b station for particle removal
24a station for closing
24b station for closing
26a burner station
26b burner station
28a station for scoring and rupturing
28b station for scoring and rupturing
30 holing station
S02 step of providing
S04 step of cooling
S06 step of processing
S12 step of providing
S14 step of detecting
S16 step of controlling
S18 step of cooling
S20 step of processing

What is claimed is:

1. A method for processing glass tube ends, comprising:
providing a glass tube blank having two tube end portions;
actively cooling at least one of the two tube end portions by a cooling station to provide an actively cooled end portion; and
processing the actively cooled tube end portion.

2. The method according to claim 1, wherein the step of actively cooling comprises actively cooling to a predefined temperature.

3. The method according to claim 1, wherein the step of actively cooling comprises using a directed coolant flow onto the actively cooled end portion.

4. The method according to claim 1, wherein the step of actively cooling comprises:
detecting the temperature of the at least one of the two tube end portions by a sensor; and
controlling the cooling station on the basis of the detected temperature of the at least one of the two tube end portions.

5. The method according to claims 1, wherein the step of processing the actively cooled tube end portion comprises:
scoring and rupturing the actively cooled tube end portion to provide a ruptured tube end portion;
closing, without thermally pre-processing, the ruptured tube end portion to provide a closed tube end portion; and
thermally post-processing the closed tube end portion.

6. A method for processing glass tube ends, comprising:
conveying glass tube blanks in a conveying direction so that a length of the tube blanks is perpendicular to the conveying direction;
actively cooling a tube end portion of each of the tube blanks as the tube blanks are conveyed in the conveying direction to provide a cooled tube end portion; and
processing the cooled tube end portion as the tube blanks are conveyed in the conveying direction.

7. The method according to claim 6, wherein the step of actively cooling comprises actively cooling both tube end portions of the tube blanks.

8. The method according to claim 6, wherein the step of actively cooling comprises directing a coolant flow onto the tube end portion.

9. The method according to claim 8, wherein the step of directing the coolant flow comprises blowing the coolant flow through a slotted nozzle that extends parallel to the conveying direction.

10. The method according to claim 8, wherein the step of directing the coolant flow comprises blowing the coolant flow through two nozzles arranged on mutually opposite sides of a horizontal plane extending in the conveying direction.

11. The method according to claim 8, wherein the step of directing the coolant flow comprises blowing the coolant flow through a nozzle while moving the nozzle in the conveying direction synchronously with the tube blanks.

12. The method according to claims 6, wherein the step of actively cooling further comprises:
detecting a temperature of the tube end portion; and
controlling cooling of the tube end portion in dependence on the temperature.

13. The method according to claims 6, wherein the step of processing the cooled tube end portion comprises:
scoring and rupturing the cooled tube end portion to provide a ruptured tube end portion;
closing, without thermally pre-processing, the ruptured tube end portion to provide a closed tube end portion; and
thermally post-processing the closed tube end portion.
